(19) United States
(12) Patent Application Publication
(10) Pub. No.: US 2003/0002124 A1
(43) Pub. Date: Jan. 2, 2003

(54) Optical free space signalling system

(76) Inventors: Alan Edward Green, Ickleton (GB); Etian Morrison, Ickleton (GB); Adrian Craig Michael Swinburne, Ickleton (GB); Robert John Morland, Ickleton (GB); Michael Reynolds, Ickleton (GB)

Correspondence Address: Fogg Slifer Polglaze, Leffert & Jay, PO Box 581009, Minneapolis, MN, 55458-1009, US

(21) Appl. No.: 10/203,310

(22) PCT Filed: Feb. 7, 2001
(86) PCT No.: PCT/GB01/00479

(30) Foreign Application Priority Data
Feb. 7, 2000 (GB) 0002768.0
Feb. 7, 2000 (GB) 0002769.8

(51) Int. Cl. G02F 1/00; G02B 5/00

(52) U.S. Cl. 359/237; 359/515

(57) ABSTRACT

There is described a signalling device having a plurality of electro-optic elements and a lens system which is operable to receive a plurality of incoming free-space light beams from respective different light sources and direct the received light beams to respective ones of the electro-optic elements. The layout and/or shape of the electro-optic elements in the signalling device is adapted in accordance with a predetermined distribution of light sources. In this way, the number of electro-optic elements can be reduced. In an alternative embodiment, there is provided a signalling device having an electro-optic device, a plurality of lens systems having respective different fields of view, and a plurality of reflecting surfaces. Each reflecting surface is associated with a corresponding one of the plurality of lens systems, and the associated reflecting surface and lens system pairs are arranged so that the electro-optic device is provided in common to the plurality of lens systems.

This invention relates to a signalling system. In particular, this invention relates to a signalling method and apparatus in which data is conveyed by modulating a light beam.

In recent years, the rapid increase in data transmitted over local area networks (LANs), wide area networks (WANs), the Internet and the like has prompted a large amount of research into increasing data transfer rates by using modulated optical beams to convey information. To date, this research has concentrated on systems in which the optical beams are transmitted along optical fibres.

A problem with using optical fibres is that their installation can be expensive and time consuming.

It has been proposed to use free-space optical beams in communication links between locations within a line-of-sight of each other in order to remove the requirement for optical fibres. International Patent Applications WO 98/35328 and WO 00/48338, the whole contents of which are incorporated herein by reference, describe point-to-multipoint communication systems utilising such free-space optical beams. In particular, WO 98/35328 and WO 00/48338 describe systems in which a plurality of user stations (provided, for example, on respective houses in a street) emit unmodulated light beams which are directed to a local distribution node (provided, for example, on a post in the street). At the local distribution node, each of the incoming light beams is modulated by a respective modulator element of an array of modulator elements, which are individually driveable in accordance with corresponding streams of data, and is reflected back to the user station from which it originated. At the user station, the modulated light beam is detected and the corresponding data stream is regenerated.

An aim of the invention is to adapt a signalling device, for example the local distribution node, in view of the environment in which it will be used.

In accordance with a first aspect of the invention, there is provided a signalling device having a plurality of modulating elements and a lens system which is operable to receive a plurality of incoming light beams from respective different light sources and direct the received light beams to respective different modulating elements, which modulate the corresponding light beams in accordance with modulation data. The layout and/or shape of the modulating elements in the signalling device is adapted in accordance with a predetermined distribution of light sources. In this way, the number of modulating elements can be reduced which in turn reduces the complexity of the signalling device.

In a preferred embodiment, the aspect ratio of the modulator elements is greater than two for the case where more light sources are expected in a first direction than in a second direction perpendicular to the first direction. This enables the number of modulating elements in the second direction to be reduced without significantly affecting coverage in the second direction. More preferably, the aspect ratio of the modulator elements is greater than five, and still more preferably the aspect ratio is greater than ten.

Preferably, the number of modulators in the second direction is one or two because this allows all the modulator elements to be addressed from their sides, thereby reducing the complexity of fabricating the signalling device.

In accordance with a second aspect of the invention, there is provided a signalling device having a plurality of detectors and a lens system which is operable to receive a plurality of incoming modulated light beams from respective different light sources and direct the received light beams onto respective different detectors, which detect the light beams and convert them into corresponding electrical signals, wherein the layout and/or shape of the detectors is adapted in accordance with a predetermined distribution of light sources. In this way, the number of detectors can be reduced which in turn reduces the complexity of the signalling device.

In a preferred embodiment, the aspect ratio of the detectors is greater than two for the case where more light sources are expected in a first direction than a second direction perpendicular to the first direction. This enables the number of detectors in the second direction to be reduced without significantly affecting coverage in the second direction. More preferably, the aspect ratio of the modulator elements is greater than five, and still more preferably the aspect ratio is greater than ten.

Preferably, the number of detectors in the second direction is one or two because this allows all the detectors to be addressed from their sides, thereby reducing the complexity of fabricating the signalling device.

In accordance with a third aspect of the invention, there is provided a signalling device having an electro-optic device, a plurality of lens systems having respective different fields of view, and a plurality of reflecting surfaces. Each reflecting surface is associated with a corresponding one of the plurality of lens systems, and the associated reflecting surface and lens system pairs are arranged so that the electro-optic device is provided in common to the plurality of lens systems. By using said plurality of reflecting surfaces, each lens system can have a longer focal length as the field of view it is required to cover is smaller. Therefore, for a given f/number, the lens systems have larger collection apertures. In this way, a field of view of up to a full 360° can be attained.

The electro-optic device may comprise an array of modulator elements. Alternatively, the electro-optic device may comprise an array of light emitting elements. As a further alternative, the electro-optic device may comprise an array of detectors.

Exemplary embodiments of the invention will now be described with reference to the accompanying drawings in which:

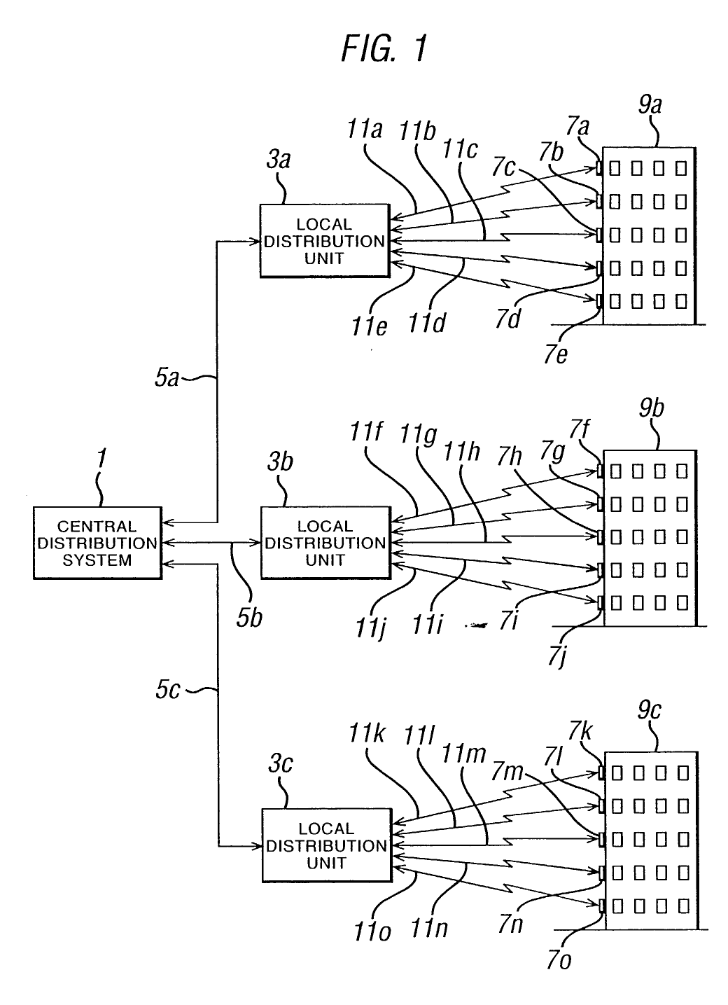

FIG. 1 is a schematic diagram of a system for distributing data to a plurality of buildings;

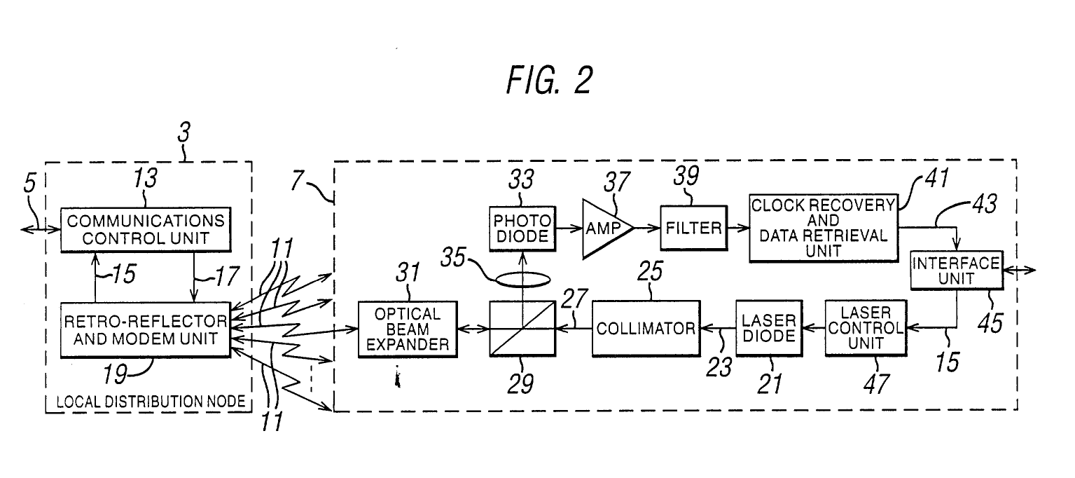

FIG. 2 is a schematic block diagram of a local distribution node and a user station which form part of the data distribution system shown in FIG. 1;

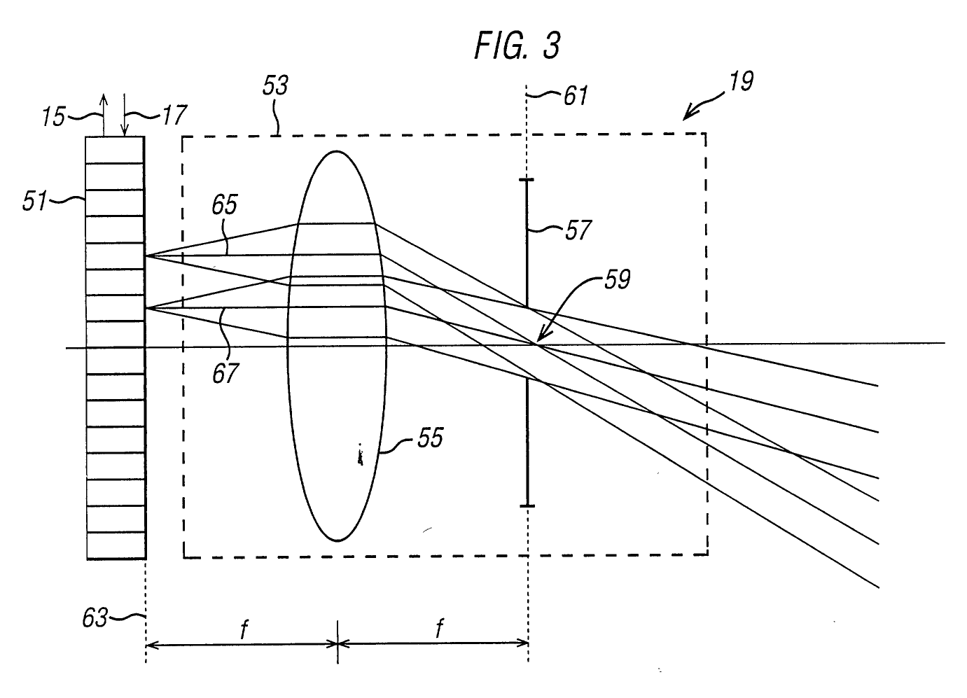

FIG. 3 is a schematic diagram showing a retro-reflector and modem unit which forms part of the local distribution node illustrated in FIG. 2;

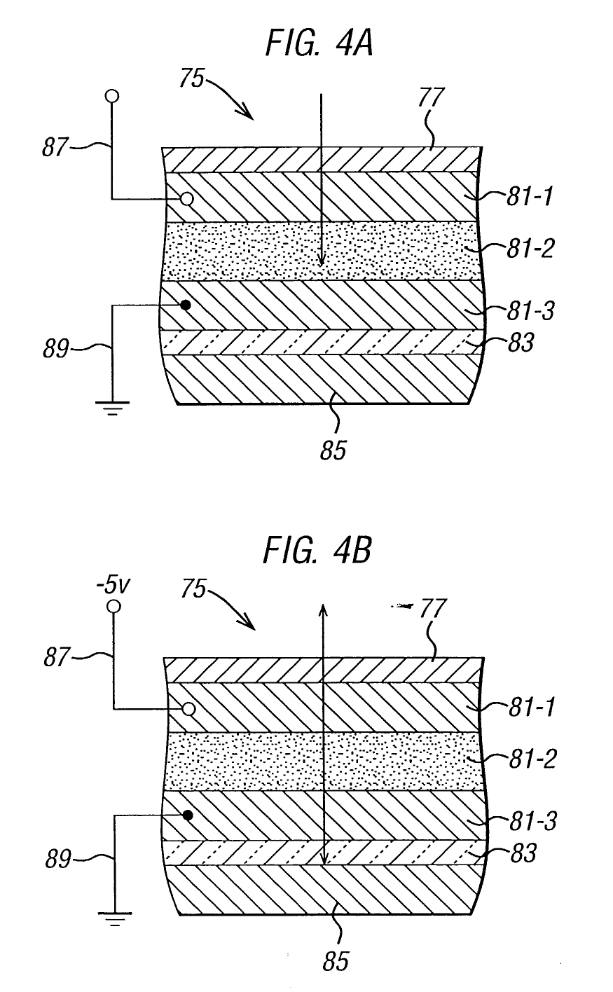

FIG. 4A is a cross-sectional view of one modulator of a pixelated modulator shown in FIG. 3 in a first operational mode when no DC bias is applied to electrodes thereof;

FIG. 4B is a cross-sectional view of one modulator of the pixelated modulator shown in FIG. 3 in a second operational mode when a bias voltage is applied to the electrodes;

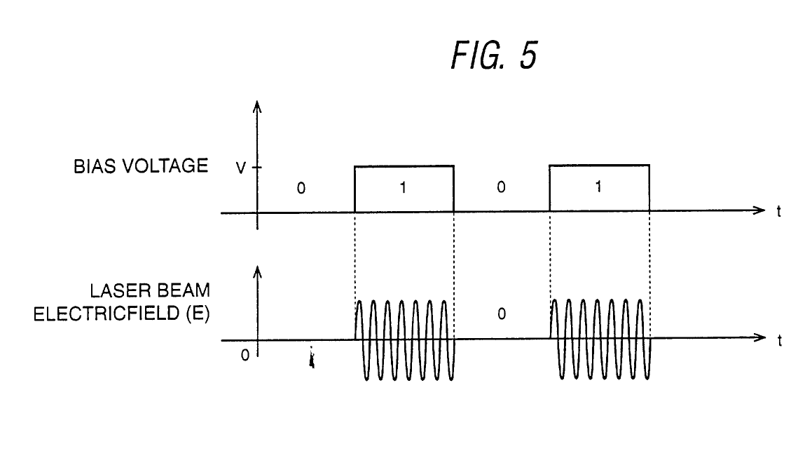

FIG. 5 is signal diagram which illustrates the way in which the light incident on a pixel of the modulator shown in FIG. 3 is modulated in dependence upon the bias voltage applied to the pixel electrodes;

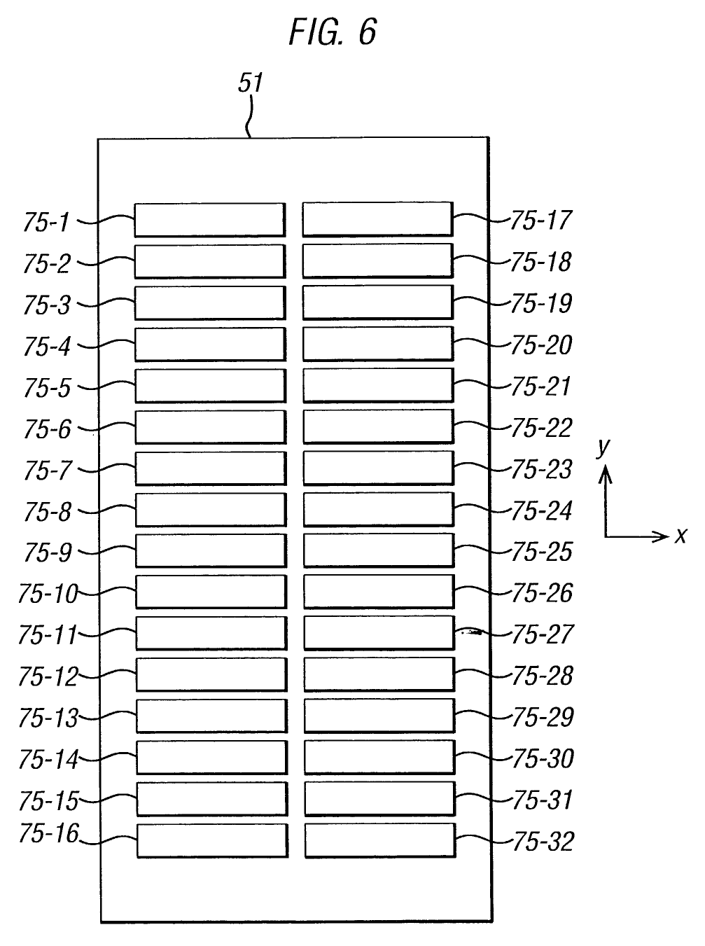

FIG. 6 is a schematic diagram of a surface of the pixelated modulator forming part of the retro-reflector and modem unit shown in FIG. 3;

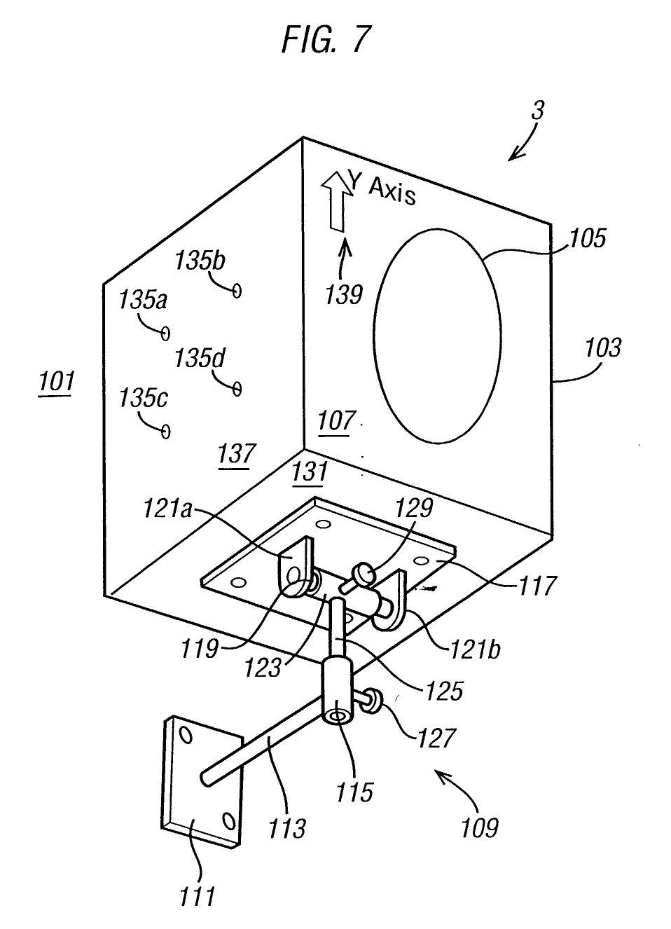

FIG. 7 is a perspective view showing a local distribution node of the data distribution system illustrated in FIG. 1 mounted to a wall of a building;

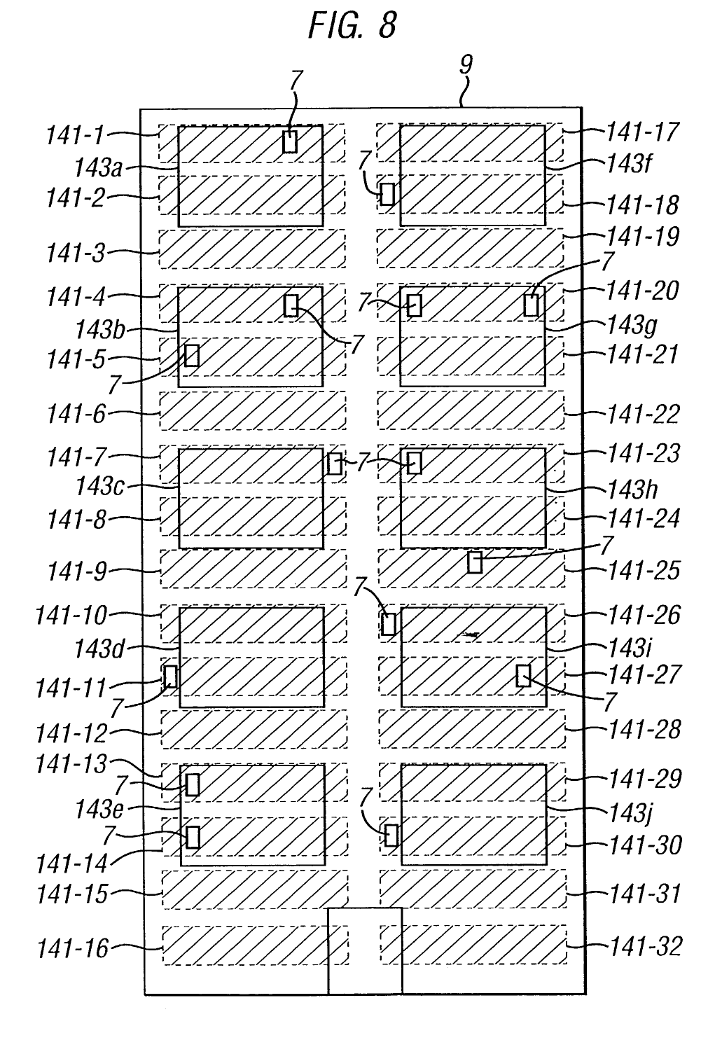

FIG. 8 is a schematic diagram illustrating the mapping of the pixels of the pixelated modulator shown in FIG. 6 to corresponding positions on a building;

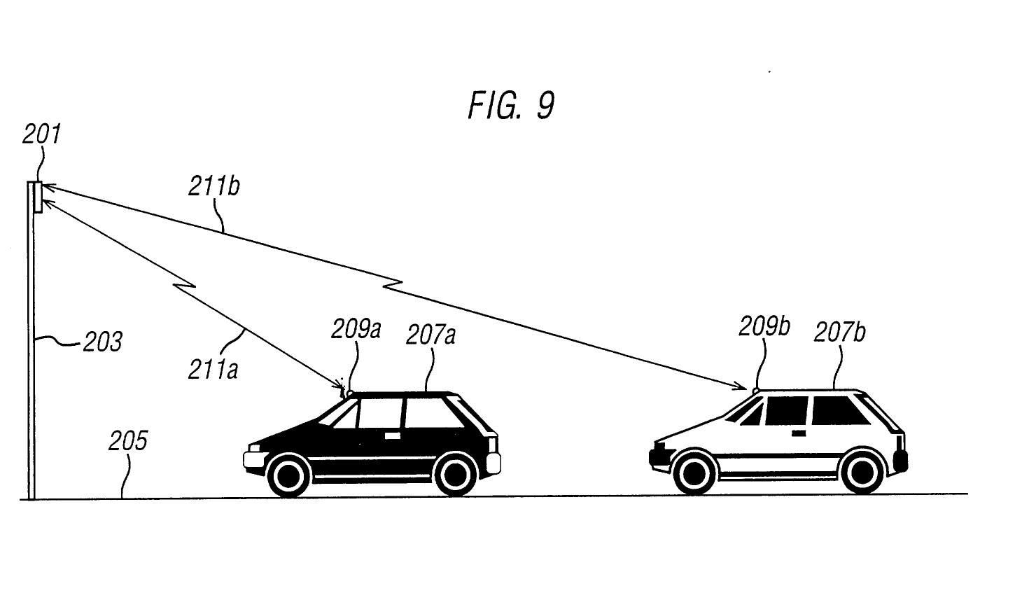

FIG. 9 is a schematic diagram of a system for distributing data to road vehicles;

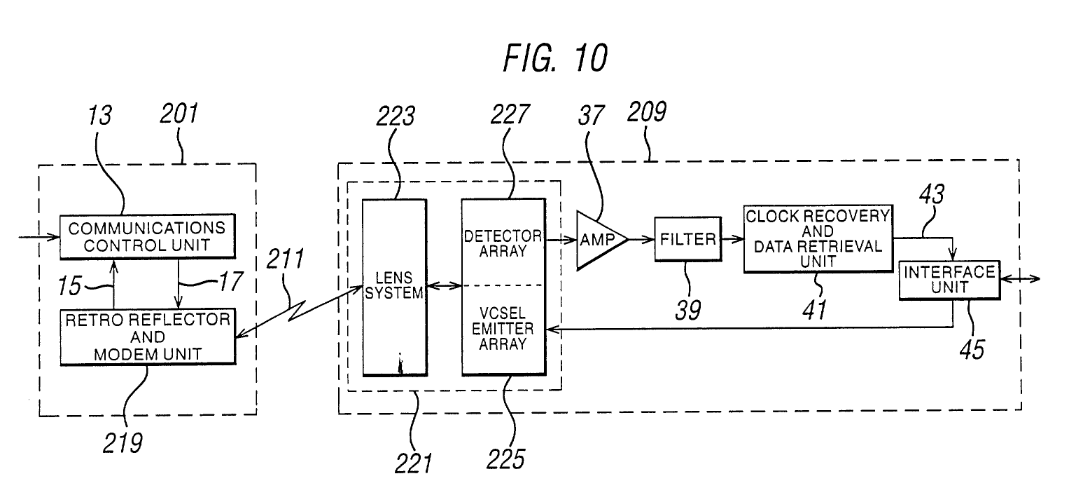

FIG. 10 is a schematic block diagram showing the form of a roadside unit and a car terminal for the data distribution system illustrated in FIG. 9;

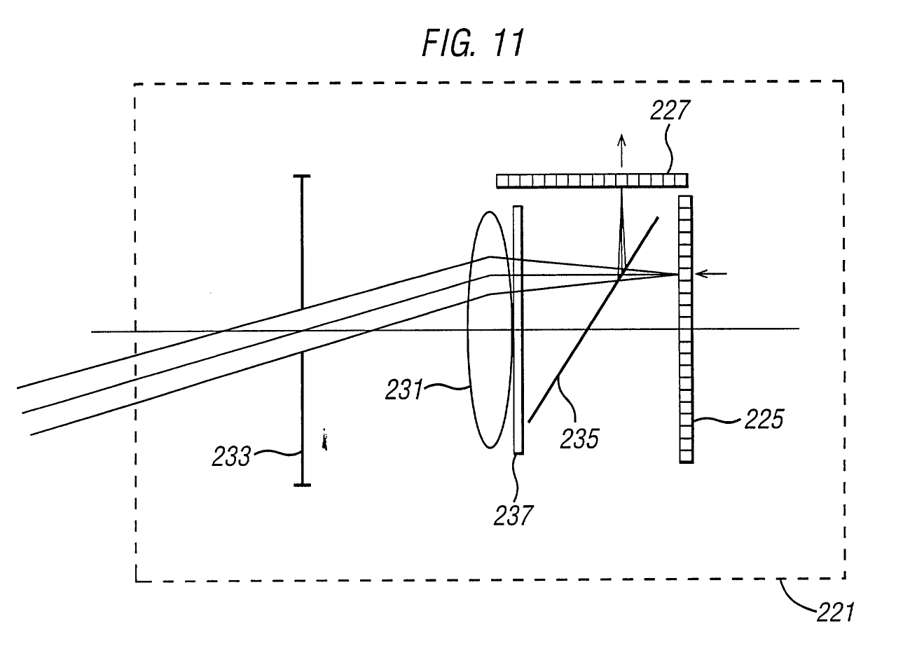

FIG. 11 is a schematic diagram showing the form of an emitter and detector array of the car terminal illustrated in FIG. 10;

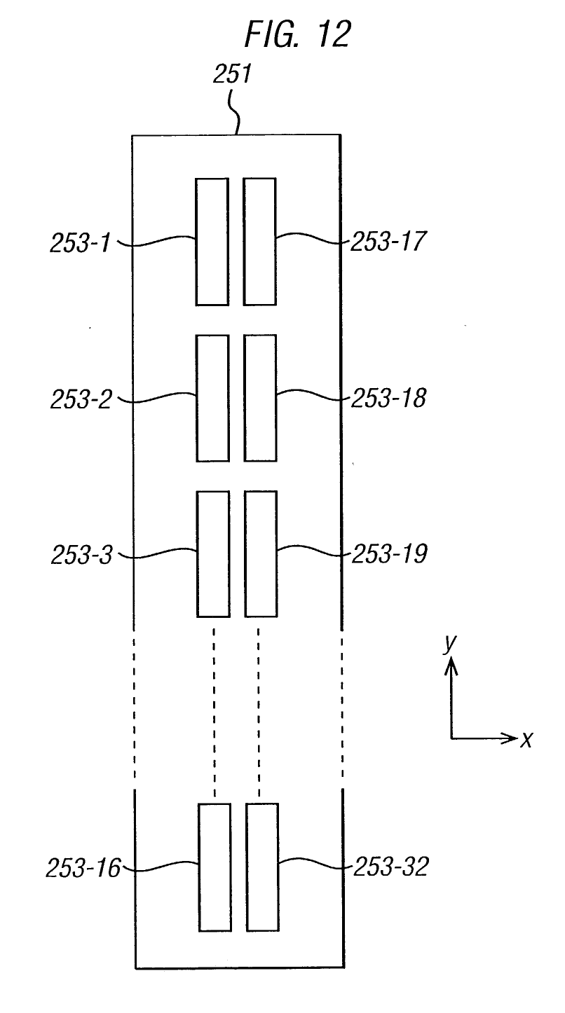

FIG. 12 is a schematic diagram showing the form of a pixelated modulator forming part of the retro-reflector and modem unit in the road terminal shown in FIG. 10;

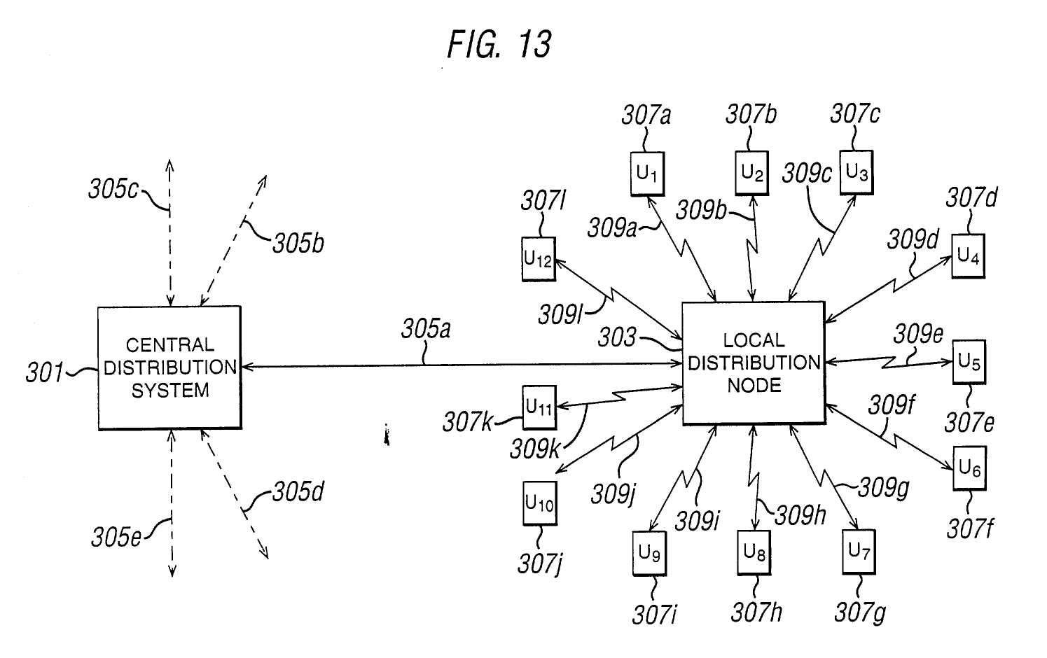

FIG. 13 is a schematic diagram of a point-to-multipoint data distribution system in which a local distribution node is surrounded in one plane by user stations;

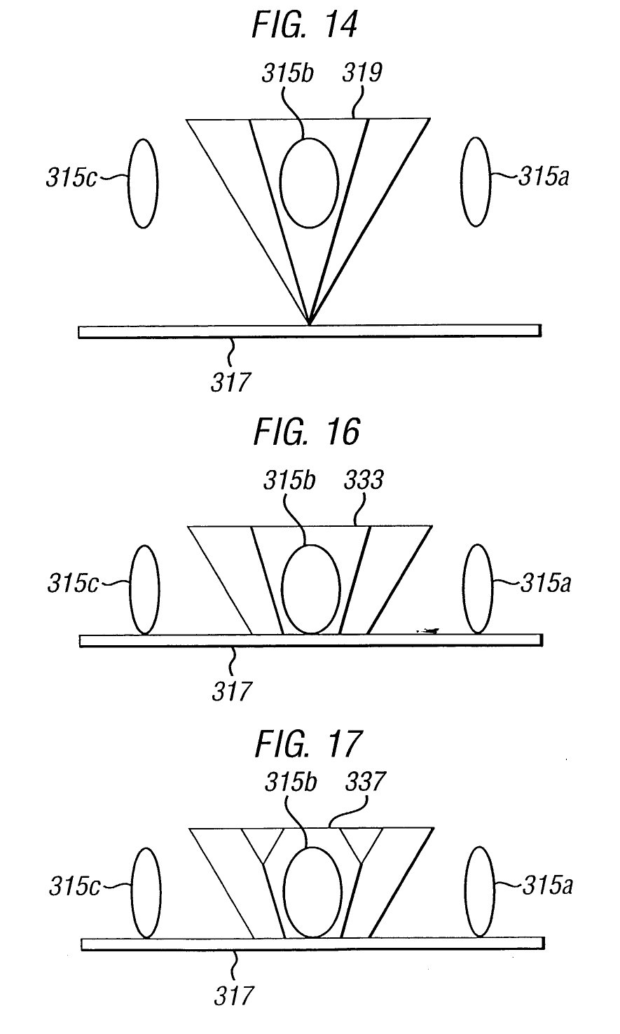

FIG. 14 is a schematic side view of components of a local distribution node of the data distribution system shown in FIG. 13;

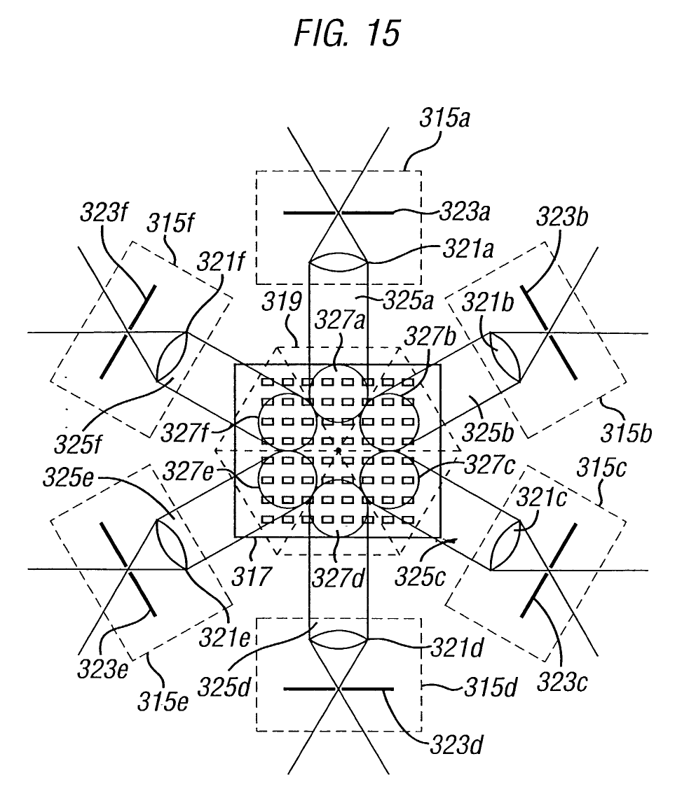

FIG. 15 is a schematic plan view of the components of the local distribution node shown in FIG. 14;

FIG. 16 is a schematic side view of a first alternative set of components for the local distribution node of the data distribution system shown in FIG. 13;

FIG. 17 is a schematic side view of a second alternative set of components for the local distribution node shown in FIG. 13; and

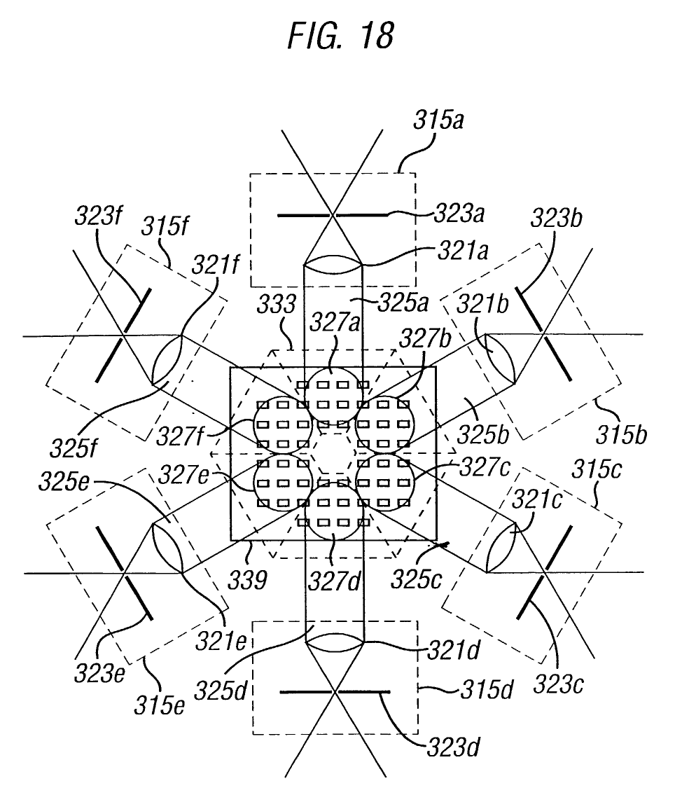

FIG. 18 is a schematic plan view of an alternative set of the components of the local distribution node shown in FIG. 14.

FIG. 1 schematically illustrates a data distribution system which employs a point-to-multipoint signalling system to transmit data to and receive data from a plurality of user stations. As shown, the data distribution system comprises a central distribution system 1 which transmits optical data signals to and receives optical data signals from a plurality of local distribution nodes 3a to 3c via respective optical fibres 5a to 5c.

At the local distribution node 3a, data streams received from the central distribution system 1 are transmitted to respective user stations 7a to 7e provided on a building 9a and data for transmission to the central distribution system 1 is received from the user stations 7a to 7e using free-space optical links 11a to 11e, i.e. optical links in which light is not guided along an optical fibre path. Similarly, data is transmitted between the local distribution node 3b and user stations 7f to 7j provided on a building 9b using free-space optical links 11f to 11j, and data is transmitted between the local distribution node 3c and local stations 7k to 7o provided on a building 9c using free-space optical links 11k to 11o. Each of the user stations 7 is connected to at least one user device (not shown) in the building 9. In this embodiment, the user devices include a television set (not shown), which transmits channel information to the central distribution system 1 and in response receives corresponding television signals, and a computer system (not shown), which accesses the Internet via the central distribution system 1.

In this embodiment, each user station 7 emits a low divergence, free-space light beam which is directed at the corresponding local distribution node 3. The emitted light beam is either modulated at the user station 7 to convey data from the user station 7 to the corresponding local distribution node 3, or is unmodulated for subsequent modulation and retro-reflection at the corresponding local distribution node 3 to convey data from the local distribution node 3 to the user station 7.

In this embodiment, each local distribution node 3 has a plurality of modulating elements (not shown in FIG. 1) which communicate with user stations 7 in corresponding parts of the corresponding building 9, with the aspect ratio of the modulating elements being adapted for the likely distribution of the users within the corresponding building 9. In particular, it has been recognised that it is unlikely that there are more than two different users in a single floor of the building, whereas each floor in the building is likely to house different users. Therefore, the number of modulator elements in the direction which corresponds to the horizontal direction on the building 9 has been reduced to two, with the length of the modulator elements in the direction corresponding to the horizontal direction being greater than the width in the direction corresponding to the vertical direction on the building 9 in order to reduce any loss of coverage of the side of the building 9.

FIG. 2 schematically illustrates in more detail the main components of one of the local distribution nodes 3 and one of the user stations 7 of the data distribution system shown in FIG. 1. As shown in FIG. 2, the local distribution node comprises a communications control unit 13 which (i) receives the optical signals transmitted along the optical fibre 5 conveying data from the central distribution system 1; (ii) regenerates the conveyed data from the received optical signals and generates corresponding drive signals 17 for the modulator elements; and (iii) receives messages 15 transmitted from the user station 7 and transmits them to the central distribution system 1 as optical signals along the corresponding optical fibre 5. When generating the drive signals 17 from the received data, the communications control unit 13 encodes the received data with error correction coding and coding to reduce the effects inter-symbol-interference and other kinds of well known sources of interference such as from the sun and other light sources.

The local distribution node 3 also comprises a retro-reflector and modem unit 19 which is arranged to receive light beams 11 from user stations 7 which are within its field of view, to modulate the respective light beam in accordance with the appropriate drive signals 17, and to reflect the modulated light beams back to the respective user station 7. In the event that an optical beam 11 received from one of the user stations 7 carries a message 15, then the retro-reflector and modem unit 19 retrieves the message 15 and sends it to the communications control unit 13 where it is processed and transmitted to the central distribution system 1.

FIG. 2 also shows the main components of one of the user stations 7. As shown, the user station 7 comprises a laser diode 21 which outputs a beam 23 of coherent light. In this embodiment, the user stations 7 are designed so that they can communicate with a local distribution node 3 within a range of 200 meters with a link availability of 99.9%. To achieve this, the laser diode 21 is 50 mW laser diode which outputs a laser beam having a wavelength of 850 nm. The output light beam 23 is passed through a collimator 25 which reduces the angle of divergence of the light beam 23. The resulting light beam 27 is passed through a beam splitter 29 to an optical beam expander 31, which increases the diameter of the light beam for transmitting to the retro-reflector and modem unit 19 located in the local distribution node 3. The optical beam expander 31 is used because a large diameter light beam has a smaller divergence than the small diameter light beam. Additionally, increasing the diameter of the light beam also has the advantage of spreading the power of the light beam over a larger area, allowing a higher powered laser diode 21 to be used while still meeting eye-safety requirements.

Using the optical beam expander 31 has the further advantage that it both provides a fairly large collecting aperture for the light beam reflected from the retro-reflector and modem unit 19 and concentrates the received reflected light beam into a smaller diameter beam. The smaller diameter reflective light beam is then split from the path of the original transmitted light beam by the beam splitter 29 and is focussed onto a photodiode 33 by a lens 35. The photodiode 33 converts the reflected light beam into an electrical signal which varies in dependence upon the drive signals 17. The electrical signal is amplified by an amplifier 37 and then filtered by a filter 39. The filtered signals are then supplied to a clock recovery and data retrieval unit 41 which regenerates the clock and the data from the central distribution system 1 using standard processing techniques. The retrieved data 43 is then passed to an interface unit 45 which is connected to the user device (not shown).

In this embodiment, the interface device 45 also receives data from the user device and generates an appropriate message 15 for transmittal to the central distribution system 1 via the local distribution node 3. This message 15 is output to a laser control unit 47 which modulates the light beam 23 output by the laser diode 21 in accordance with the message 15. In this embodiment, a half-duplex communications link, in which at any one time data is transmitted in only one direction between the user station 7 and the corresponding local distribution node 3, is set up in order to avoid interference between signals travelling in opposite directions.

The structure and function of the components in the user station 7 are well known to those skilled in the art and a more detailed description of them shall therefore be omitted.

FIG. 3 schematically illustrates the retro-reflector and modem unit 19 which is used in this embodiment. As shown, the retro-reflector and modem unit 19 comprises a modulator array 51 and a telecentric lens 53, which is formed by a lens 55 and a stop member 57 having a central aperture 59. The stop member 57 and the modulator array 51 are optically located in the front focal plane 61 and the back focal plane 63 of the telecentric lens 53 respectively. Although for clarity the lens 55 is shown as a single lens element, those skilled in the art will appreciate that in practice more than one lens element is likely to be used in the telecentric lens 53 with the exact arrangement being a design choice depending on the particular requirements of installation. The size of the aperture 59 is also a design choice, with a large aperture 59 transmitting more of the light from the user stations 7 than a small aperture 59 but requiring a more complex and expensive lens 55 to focus the light than is required with a small aperture 59. In practice, however, there is generally little benefit in increasing the size of the aperture 59 beyond the point where the transmission loss of the lens system 53 becomes negligible in comparison with atmospheric loss of the free space optical beam.

In this embodiment, the telecentric lens 53 has a field of view which covers 60° in both the horizontal and vertical directions.

The telecentric lens 53 focusses incident light onto the back focal plane 63 at a position which is related to the angle of incidence of the light. In this way, different angles of incidence within the field of view of the telecentric lens 53 are mapped to different positions in the modulator array 51. Further, the principal rays 65 and 67 transmitted through the telecentric lens 53 are incident perpendicular to the back focal plane 63 and therefore the modulator array 51 reflects the incident light back along its path of incidence. In this way, the modulator 51 and telecentric lens 53 act as the retro-reflector. Those skilled in the art will appreciate that by using the telecentric lens 53, the modulator array 51 can advantageously be formed using conventional planar semiconductor processing techniques because light from the telecentric lens 53 is incident normal to the planar surface of the modulator array 51 and is therefore reflected back along its path of incidence. Another advantage of using the telecentric lens 53 is that the efficiency of modulation, i.e. the modulation depth, of existing optical modulators generally depends upon the angle at which the light beam hits the modulator. However, using the telecentric lens 53 ensures that the principal rays of the light beams are incident parallel to the optical axis of the modulators regardless of the position of the user station 7 within the field of view of the telecentric lens 53 and therefore the dependency of the efficiency of modulation upon the position of the user station 7 relative to the local distribution node 3 is substantially removed.

In this embodiment, the modulator array 51 comprises a two-dimensional array of Quantum Confined Stark Effect (QCSE) devices (which are sometimes also referred to as Self Electro-optic Devices or SEEDs). FIG. 4A schematically illustrates the cross-section of one of the QCSE devices 75. As shown, the QCSE device 75 comprises a transparent window 77 through which the light beam 11 from the appropriate user station 7 passes, followed by three layers 81-1, 81-2 and 81-3 of Gallium Arsenide (GaAs) based material. Layer 81-1 is a p-conductivity type layer, layer 81-2 is an intrinsic layer having a plurality of quantum wells formed therein, and layer 81-3 is an n-conductivity type layer. Together, the three layers 81-1, 81-2 and 81-3 form a p-i-n diode. As shown, the p-conductivity type layer 81-1 is connected to an electrode 87 and the n-conductivity type layer 81-3 is connected to a ground terminal 89. A reflective layer 83, in this embodiment a Bragg reflector, is provided beneath the n-conductivity type layer 81-3, and a substrate layer 85 is provided beneath the reflective layer 83.

In operation, the light beam 11 from the user station 7 passes through the window 77 into the gallium arsenide based layers 81. The amount of light absorbed by the intrinsic layer 81-2 depends upon the DC bias voltage applied to the electrode 87. Ideally, when no DC bias is applied to the electrode 87, as illustrated in FIG. 4A, the light beam passes through the window 77 and is totally absorbed within the intrinsic layer 81-2. Consequently, when there is no DC Bias voltage applied to the electrode 87, no light is reflected back to the corresponding user station 7. On the other hand, when a DC bias voltage of approximately −5 volts is applied to the electrode 87, as illustrated in FIG. 4B, the light beam from the corresponding user station 7 passes through the window 77 and the Gallium Arsenide based layers 81 and is reflected by the reflecting layer 83 back upon itself along the same path to the corresponding user station 7. Therefore, by changing the bias voltage applied to the electrode 87 in accordance with the drive signals 17 from the communications control unit 11, the QCSE modulator 75 amplitude modulates the received light beam and reflects the modulated light beam back to the user station 7.

In the ideal case, as illustrated in FIG. 5, a zero voltage bias, resulting in no reflected light, is applied to the electrode 87 to transmit a binary 0 and a DC bias voltage of −5 volts is applied to the electrode 87, resulting in the light from the user station 7 being reflected back from the QCSE device 75, to transmit a binary 1. In practice, however, the QCSE modulator 75 will reflect typically 70% of the light beam when no DC bias is applied to the electrode 87 and 95% of the light beam when −5V DC bias is applied to the electrode 87. Therefore, in practice, there will only be a difference of about 25% between the amount of light which is detected at the user station 7 when a binary 0 is transmitted and when a binary 1 is transmitted.

The amount of the received light beam absorbed by the intrinsic layer 81-2 can be increased by adding additional quantum wells to increase the depth of the intrinsic layer 81-2. However, if the depth of the intrinsic layer 81-2 is increased, then a higher voltage must be applied to the electrode 87 in order to produce the required electric field across the intrinsic layer 81-2 for allowing light to pass through the intrinsic layer 81-2. There is, therefore, a trade-off between the absorptivity of the intrinsic layer 81-2 and the voltage applied to the electrode 87.

By using the QCSE modulators 75, modulation rates of the individual modulator cells in excess of a Gigabit per second can be achieved.

In this embodiment, the QCSE modulators 75 are also used to detect modulated light beams from the user stations 7, taking advantage of the fact that each QCSE modulator is p-i-n diode.

FIG. 6 shows the surface of the modulator array 51. As shown, the modulator array 51 is a two-dimensional array with sixteen modulator elements 75 provided in a Y-direction and two modulator elements 75 provided in an X-direction perpendicular to the Y-direction. Those skilled in the art will appreciate that, by having only two modulators in the X direction, the fabrication of the modulator array 51 is greatly simplified because the modulator elements 75 can be addressed from the sides of the array.

In this embodiment, each modulator element 75 has a length of approximately 1 mm in the X direction and a width of approximately 100 μm in the Y direction. As discussed previously, in this embodiment the shape of the modulator element 75 has been selected to match the likely distribution of users within the building 9. In particular, the modulator array 51 is aligned so that the X direction corresponds to the horizontal direction on the building 9 and the Y direction corresponds to the vertical direction in the building 9, and less modulator elements 75 are provided in the X direction than in the Y direction because the users are expected to be predominantly distributed in the Y direction. The length of the modulator elements 75 in the X direction is made longer than the width in the Y direction to ensure adequate coverage of the side of the building 9.

Due to the non-uniformity in the X and Y directions of the layout of the modulator elements 75, a person installing the local distribution node 3 must be able to determine the orientation of the modulator elements 75 in order to align the local distribution node 3 so that the X direction corresponds to the horizontal direction on the building 9. FIG. 7 shows a local distribution node 3 mounted to the wall 101 of a building. As shown, the electrical and optical components of the local distribution node 3 are mounted in a housing 103 having a window 105, formed on a side 107 of the housing 103, through which light beams from the user stations 7 can pass to the telecentric lens 53.

The housing 103 is mounted to the wall 101 using a mount (indicated generally by 109) which includes a plate 111 which can be bolted to the wall 101. An arm 113 protrudes perpendicularly from the plate 111 and terminates with an elongate hollow cylinder 115 whose longitudinal axis is vertically aligned. The mount 109 also includes a plate 117 which is bolted to the housing 103 and which has an elongate rod 119 mounted parallel with the surface of the plate 117 by supports 121a and 121b. The rod 119 is rotatably mounted within an elongate cylinder 123. An elongate bar 125 with a circular cross-section extends radially from a point halfway along the length of the cylinder 123, and the end of the bar 125 remote from the cylinder 123 is inserted in the cylinder 115.

The elongate bar 125 is rotatable within the cylinder 115 to enable rotation of the housing 103 about a vertical axis and the elongate rod 119 is rotatable within the cylinder 123 to enable rotation of the housing 103 about a horizontal axis. Once the correct alignment of the housing 103 is achieved, then the elongate bar 125 can be fixed within the cylinder 115 by tightening a screw 127 and the elongate rod 119 can be fixed within the cylinder 123 by tightening a screw 129.

As shown in FIG. 7, the plate 117 is mounted to a side 131 of the housing 103 which is adjacent to the side 107 in which the window 105 is formed. However, bolt-holes 135a to 135d are also provided on a side 137 which is adjacent both to the side 107 and the side 131 of the housing 103, so that the housing 103 can be mounted in an orientation which is 90° to that illustrated in FIG. 7. A visible marking 139 is formed on the housing 103 in order to indicate the Y direction of the modulator array. Thus, on installation the local distribution node 3 can either be arranged with the Y direction substantially vertical (as shown in FIG. 7) or substantially horizontal, depending on the distribution of users within the field of view.

As discussed above, the telecentric lens 53 maps each direction within its field of view to a respective position on the modulator array 51. FIG. 8 shows a building 9 within the field of view of a local distribution node 3 in which the regions of the building 9 corresponding to each of the modulator elements 75 within the local distribution node 3 are schematically indicated by the hatched boxes 141-1 to 141-32. As shown, user stations 7 are located at various positions by the side of the building 9.

In this embodiment, the building 9 has six floors with each of the top five floors having two windows 143a to 143j facing the local distribution node 3. As schematically shown by the hatched areas 141 in FIG. 8, each window 143 has two separate portions which map to respective different modulator elements 75. Further, the modulator elements 75 corresponding to portions of a window 143 also correspond to regions adjacent the sides of the window 143, and modulator elements which do not correspond to a portion of a window 143 map to other parts of the building 9.

In this embodiment, the layout of the modulator elements 75 which form the modulator array has been designed to be especially suited to the building 9 as illustrated in FIG. 8. In particular, it has been recognised that each of the windows 143 is likely to correspond to an individual user and that it is unlikely that an individual user will require many different optical links. Further, the shape of the modulator element has been selected to suit the area of a building corresponding to a single user, in particular by increasing the aspect ratio. Those skilled in the art will appreciate that the same data will be transmitted to all user stations 7 within the region covered by a single modulator element 75, i.e. all user terminals 7 falling within a hatched box 141 will receive the same data.

As shown in FIG. 8, a user station 7 can be placed either in a window 143 (see, for example, hatched box 141-1), by the side of a window 143 (see, for example, hatched box 141-18), or below a window 143 (see, for example hatched box 141-25). If a user does require more than one optical link, then two user stations can be located in or around the appropriate window in positions corresponding to different modulator elements 75 (see, for example, hatched boxes 141-4 and 141-5). Further, two user stations 7 can be located in positions corresponding to a single modulator element 75 (see, for example, hatched box 141-20) in order to provide a backup optical link in case an optical link is interrupted by, for example, a bird or a raindrop.

To summarise, in the first embodiment the layout and shape of the modulator elements 75 forming the modulator array 51 is designed to be especially suited for a particular environment of use, in particular a multi-storey building. A particular advantage of the layout in the first embodiment is that, following the realisation that only two different users are likely to be present on a single floor of a multi-storey building, the modulator elements are arranged in an “n-by-2” array, having n modulators in a first direction and 2 modulators in a second direction perpendicular to the first direction, which allows each modulator element to be addressed from the side, thereby greatly simplifying the design and fabrication of the modulator array 51.

In the first embodiment, a data distribution system is described in which data is transmitted between a local distribution node 3 and a user station 7 which are fixed relative to each other. A second embodiment of the invention will now be described in which data is transmitted between a local distribution node and a user station which move relative to each other.

FIG. 9 schematically illustrates the data distribution system of the second embodiment. As shown, a local distribution node 201 is mounted at the top of a post 203 which is positioned beside a road 205. The field of view of the local distribution node 201 encompasses a corresponding distance along the road 205. As shown, cars 207a and 207b travelling along the road 205 each have a respective user station 209a and 209b, hereinafter referred to as car terminals 209, which optically communicate with the local distribution node 201. As in the first embodiment, the local distribution node 201 is operable to receive data from a central distribution system (not shown) and to transmit appropriate data to the car terminals 209 via low divergence, free-space light beams 211a and 211b. The local distribution node 201 is also operable to receive data transmitted from the car terminals 209 and to forward the received data to the central distribution system.

In this embodiment, the car terminal 209 is connected to an input device (not shown), via which a passenger in the car 207 can request information from the central distribution system, and a display (not shown) for displaying the received, requested information.

FIG. 10 schematically illustrates in more detail the main components of the-local distribution node 201 and one of the car terminals 209 of the system shown in FIG. 9. Components which are the same as corresponding components in the first embodiment have been referenced by the same numerals and will not be described again.

As shown in FIG. 10, in this embodiment the car terminal 209 includes an emitter and detector array and lens system 221 comprising a lens system 223, an emitter array 225 and a detector array 227. In this embodiment, the emitter array 225 comprises a two-dimensional pixelated array with a vertical cavity surface emitting laser (VCSEL) positioned at each pixel. The use of VCSELs is preferred because the emitter array 225 can then be manufactured from a single semiconductor wafer, without having to cut the wafer. This allows a higher density of lasing elements than would be possible with traditional diode lasers. VCSEL arrays which output light beams having a wavelength in the region of 850 nm within the power range of between 1 mW and 30 mW are available from CSEM SA, Badenerstrasse 569, 8048 Zurich, Switzerland.

In this embodiment, each VCSEL in the emitter array 225 outputs either a modulated light beam conveying a message received from the input device in the car 207 or an unmodulated light beam which is modulated at the local distribution node 201 and reflected back to the car terminal 209. The lens system 223 directs the emitted light beam in a direction within its field of view corresponding to the position of the VCSEL emitting the light beam. As light emitted from each VCSEL is mapped to a different angle or direction within the field of view of the lens system 223, by selectively driving the emitter elements in the VCSEL array 225, the direction of the emitted light beam within the field of view can be varied. The lens system 223 also directs a received modulated light beam, conveying data from the local distribution node 203, onto the detector array 227. In this embodiment, the detector array 227 is a two-dimensional array of photodiodes.

The electrical signals output by the detector array 227, which will vary in dependence upon the data conveyed by the modulated light beam, are amplified by the amplifier 37, filtered by the filter 39, and then supplied to the clock recovery and data retrieval unit 41 which regenerates the clock and the original data using standard processing techniques. The retrieved data 43 is then input to the interface unit 45 which interfaces with the display (not shown) in the car 207.

FIG. 11 shows in more detail the emitter and detector array and lens system 221 in the car terminal 209. As shown, the VCSEL emitter array 225 is optically positioned in the back focal plane of a telecentric lens represented by the lens 231 and the stop member 233. The stop member 233 is optically located in the front focal plane of the telecentric lens. The purpose of employing a telecentric lens is to ensure that the collection efficiency (of light from the emitter array 225) of the lens is constant across the emitter array 225. Therefore, provided all the emitters are the same, the intensity of the light output from the car terminal 209 will be the same for each emitter. Those skilled in the art will appreciate that with a conventional lens the intensity of the light output from the car terminal 209 would be greater for light emitted by emitters in the centre of the array than for light emitted by emitters at the edge of the array. The use of a telecentric lens also avoids various cosine fall-off factors which are well known in conventional lenses.

In this embodiment, each VCSEL emits a linearly-polarised, divergent light beam which is transmitted through a polarisation beam splitter 235 and a quarter-wave plate 237, which converts the linearly-polarised light into left-handed circularly polarised light. The light beam is then incident on the telecentric lens which substantially collimates the light beam and directs it in a direction corresponding to the position of the originating VCSEL. The light beam reflected back from the roadside unit 201, which will be formed by right-handed circularly polarised light, is collected by the telecentric lens and directed through the quarter-wave plate 237, which converts the right-handed circularly-polarised light into linearly-polarised light whose polarisation is orthogonal to the linearly-polarised light emitted by the VCSELs in the emitter array 225. The polarisation beam splitter 235 therefore reflects the light from the local distribution node 201 onto the detector array 227, which is also optically located in the back focal plane of the telecentric lens.

As shown in FIG. 11, in this embodiment only one VCSEL in the emitter array 225 is operated at a time. As discussed above, by changing the VCSEL which is operated it is possible to vary the direction of the emitted beam. Further, the light received from the roadside unit 201 will be focussed at a position on the detector array 227 which corresponds to the direction of the emitted beam. In this embodiment, the signals from the individual detector elements are monitored, and based on the monitored signals a tracking operation is performed in which the VCSEL element which is driven is changed in order to vary the direction of the emitted light beam to maintain the optical link between the car terminal 209 and the local distribution node 201.

The retro-reflector and modem unit 219 of the second embodiment is the same as the retro-reflector and modem unit 19 of the first embodiment (as illustrated in FIG. 3) except for the layout of the modulator elements in the modulator array. FIG. 12 shows the surface of the modulator array 251 of the second embodiment. As shown, the modulator array 251 is a two-dimensional array with sixteen modulator elements provided in the Y direction and two modulator elements provided in the X direction. As in the first embodiment, by having only two modulator elements in the X direction the fabrication of the modulator array is greatly simplified because the modulator elements can be addressed from the sides of the array. In this embodiment, each modulator element has a length of approximately 1 mm in the Y direction and a width of approximately 100 microns in the X direction.

In this embodiment, the local distribution node 201 is mounted to the post 203 so that the Y direction is substantially vertical and therefore the modulator elements are mapped along the road 205. In particular, the local distribution node 201 is designed so that the width of the modulator element corresponds to the width of a lane of the road, while the length of the modulator element corresponds to a distance along the road which is significantly longer than the width of a lane. This has the advantage that a single modulator element 253 is used to communicate with a car terminal 209 for a longer period of time than would be the case if the length of the modulator element was equal to the width of the modulator element. This therefore reduces the complexity of the local distribution node 201 because less modulator elements are required and because fewer changeovers between modulator elements are required as the car 207 moves within the field of view of the local distribution node 201.

In the first and second embodiments, the local distribution node was adapted to take account of the environment in which it will be used. In particular, in the first and second embodiments the layout and shape of modulator elements in the modulator array was chosen either to match the distribution of users in a building or to match the expected path to be taken by mobile user stations.

The local distribution nodes of the first and second embodiments are able to communicate with user stations within a horizontal field of view of approximately 60°. In some applications a larger field of view is required. However, increasing the field of view while retaining a large collection aperture is problematic because a very low f/number lens is required. A third embodiment will now be described in which the local distribution node has a full 360° horizontal field of view. In particular, in the third embodiment the local distribution node is horizontally surrounded by user stations and therefore a 360° horizontal field of view is required.

FIG. 13 schematically illustrates the data distribution system of the third embodiment. As shown, a central distribution system 301 transmits data to and receives data from a local distribution node 303 via a bundle of optical fibres 305a. The central distribution system 301 also transmits data to and receives data from other local distribution nodes (not shown) via respective optical fibre bundles 305b to 305e. The local distribution node 303 is located in the centre of twelve user stations 307a to 307l. In this embodiment, the local distribution node 303 is mounted on a post (not shown) in the centre of a square surrounded by buildings (not shown), and the user stations 307 are mounted on the buildings.

The components of the user stations 307 are the same as the user stations of the first embodiment and therefore will not be described in detail again.

FIG. 14 is a schematic side view of the key components of the local distribution node 303 (with the housing and component mountings removed to improve clarity). The local distribution node 303 comprises six telecentric lenses, three of which can be seen in FIG. 14 represented as single lenses 315a to 315c. Each of the telecentric lenses 315 has a horizontal field of view of about 60° and is positioned to cover a respective portion of the horizontal plane so that the six telecentric lenses cover between them a 360° horizontal field of view.

In this embodiment, light from all of the telecentric lenses 315 is reflected onto a single modulator array 317 by a pyramidal reflector 319 which has a hexagonal base and six triangular sides, which are inclined at 45° to the plane of the base. The pyramidal reflector 319 is positioned so that the apex is adjacent the modulator array 317 and the base is parallel with the plane of the modulator array 317, and the telecentric lenses 315 are arranged around the pyramidal reflector 319 so that light passing through each telecentric lens 315 is directed horizontally onto a respective side of the pyramidal reflector 319 where it is reflected vertically downwards onto the modulator array 317. The telecentric lenses 315 are positioned so that the modulator array 317 is optically located in the back focal plane of all six telecentric lenses 315.

FIG. 15 shows a schematic top plan view of the key components of the local distribution node 303 in which the outline of the pyramidal reflector 319 is shown in phantom lines in order to reveal the modulator array 317 beneath. As shown, the telecentric lenses 315a to 315f are formed by respective lenses 321a to 321f and stop members 323a to 323f. The telecentric lenses 315 collect light within their field of view and direct the collected light as horizontal light beams 325a to 325f to the pyramidal reflector 319, where the light beams are reflected vertically downwards onto the modulator array 317 by respective sides of the pyramidal reflector 319 to form corresponding spots 327a to 327f on the modulator array 317. Therefore, as in the first and second embodiments, the telecentric lenses 315 map incoming light from different directions onto respective different positions on the modulator array 317, which modulates the light and reflects the modulated light back in the direction from which the incoming light beam originated.

As shown in FIG. 15, in this embodiment the modulator array comprises an eight-by-eight array of modulator elements. The user stations 307 are positioned so that when the low-divergence free-space light beams emitted by the user stations are directed onto the local distribution node 303, the emitted light beam are directed onto corresponding modulator elements which modulate and reflect the light beam back to the originating user stations.

Those skilled in the art will appreciate that by using six reflectors to reflect light from six telecentric lenses 315 onto a single modulator array 317, the fabrication of the local distribution node is simplified because electrical connections only need to be made to a single device. Further, by mounting the six reflectors onto a single body the fabrication of the local distribution node is still further simplified.

### MODIFICATIONS AND FURTHER EMBODIMENTS

In the third embodiment, each side of a six-sided pyramidal reflector 319 reflects incoming light beams onto a single integrated modulator array. However, only part of each side actually reflects light during use. Therefore, the portions of the sides which do not reflect light during use do not need to be made reflective. Further, these unused portions could be removed entirely.

FIG. 16 is a schematic side view of a first alternative embodiment having a reflector 333 with the form of a six-sided frustum, i.e. a six-sided pyramid with the apex portion, which does not reflect light in use, removed. Those skilled in the art will appreciate that the telecentric lenses 315 are still positioned so that their back focal planes are optically located in the plane of the modulator array 317. As shown in FIG. 16, the smaller base portion of the frustum can be glued (or attached in any other way) to the modulator array 317 because, as can be seen in FIG. 15, the modulator elements in the centre of the modulator array 317 are not required during use. This ensures a robust alignment between the modulator array 317 and the reflector 333.

FIG. 17 is a schematic side view of a second alternative embodiment having a reflector 337 with the form of a six-sided frustum in which the tips of the hexagonal base have been sliced off at an angle of 45° to the plane of the base so that each of the reflecting sides is in the form of a hexagon.

In the third embodiment, six telecentric lenses, which each have a horizontal field of view of about 60°, are used with a six-sided pyramidal reflector to map a 360° horizontal field of view onto respective positions on the single modulator array 317. Those skilled in the art will appreciate that the field of view of each telecentric lens could be increased or reduced and the number of reflecting side surfaces of the pyramidal reflector altered accordingly to maintain a full 360° horizontal field of view. For example, telecentric lenses having a horizontal field of view of 45° could be used with an eight-sided pyramidal body.

In some circumstances, the required horizontal field of view is less than 360° but still more than can be handled by a single telecentric lens. Those skilled in the art will recognise that a reflector can readily be designed for use with two or more telecentric lenses so that a single integrated modulator array can be used.

Although in the third embodiment a 360° field of view was required in a horizontal plane, the local distribution node 303 can be rotated to cover a 360° field of view in any plane.

In the third embodiment and the embodiments illustrated in FIGS. 16 and 17, some of the modulator elements of the modulator array 317 are not used, and are therefore redundant, because no light from the telecentric lenses 315 is incident on them (as can be seen clearly in FIG. 15). FIG. 18 shows an alternative embodiment in which the frustum-shaped reflector 333 shown in FIG. 16 is used with a modulator array 339 in which the redundant modulator elements have been removed. In particular, modulator elements have been removed from the corners of the modulator array 339 and the centre of the modulator array 339. Those skilled in the art will appreciate that the modified modulator array 339 could also be used with the pyramidal reflector 319 shown in FIG. 14 or the reflector 337 shown in FIG. 17.

In the third embodiment, the modulator elements of the modulator array are rectangular. The shape of modulator elements can be adapted in the manner described in the first and second embodiments to take account of the environment in which the local distribution node will be used.

In the first to third embodiments QCSE modulators are used. As those skilled in the art will appreciate, other types of reflectors and modulators could be used. For example, a plane mirror may be used as the reflector and a transmissive modulator (such as liquid crystal) could be provided between the lens and the mirror.

In the first to third embodiments, the QCSE modulators are also used to detect modulated light beams from the user stations. Those skilled in the art will appreciate that separate detecting elements could be used, either integrated with the modulating elements with a detecting element being provided adjacent each modulating element, or a separate detector array being provided with beam splitters being used to direct part of the incoming light transmitted through the telecentric lens onto the detector array.

If separate detecting elements are used, then they can also be shaped in the manner described in the first and second embodiments to take account of the environment in which the local distribution node will be used. Further, in an alternative embodiment, an array of light emitters, for example a VCSEL array, may be provided in the local distribution node which emit modulated light beams to convey data to the user stations, and modulated light beams from the user stations are directed onto corresponding detector elements of a detector array whose layout and shape have been chosen in view the environment in which the local distribution node is being used.

In the first embodiment, a marking was provided on the housing of the local distribution node to indicate the orientation of the modulator array within the housing. Instead of using a marking, the orientation of the modulator array within the housing could be apparent from the shape of the housing, i.e. the housing could be a rectangular box having long edges which correspond to the y-direction.

It is possible to determine the orientation of the modulator array, without any indication on the housing, by looking through the window of the telecentric lens to view the modulator array directly. However, this is not preferred because it requires the installer to interpret the appearance of the face of the modulator array correctly and therefore requires the installer to have an increased level of expertise.

Rather than customising local distribution nodes for individual locations, a set of local distribution nodes having modulator arrays with respective different arrangements of modulator elements could be provided. An installer would then analyse the environment in which the local distribution node is to be used and select the most appropriate local distribution node from the set of local distribution nodes for installation. Those skilled in the art will appreciate that the set of local distribution nodes can therefore be mass produced, thereby reducing fabrication costs.

Although, as discussed above, telecentric lenses have many advantages both when used with a modulator array and when used with an emitter array, alternative lens systems could be employed.

1. A signalling device comprising:
a lens system for collecting light incident on the signalling device;
a reflector for reflecting light collected by the lens system back through the lens system; and
a modulator for modulating the light collected by the lens system and/or for modulating the reflected light in accordance with modulation data,
wherein the modulator comprises a plurality of modulating elements, each modulator element extending a first length in a first direction and a second length, which is greater than twice the first length, in a second direction perpendicular to the first direction.

2. A signalling device according to claim 1, wherein the second length is greater than five times the first length.

3. A signalling device according to claim 1, wherein the second length is greater than ten times the first length.

4. A signalling device according to any preceding claim, wherein each modulating element is rectangular.

5. A signalling device according to any preceding claim, wherein the lens system is a telecentric lens system.

6. A signalling device according to any preceding claim, wherein the plurality of modulator elements are arranged in an array.

7. A signalling device according to claim 6, wherein the array is a two-dimensional array.

8. A signalling device according to claim 7, wherein the two-dimensional array has a plurality of modulators arranged in a first array direction and two modulators arranged in a second array direction.

9. A signalling device according to claim 8, wherein said first array direction is parallel to said first direction.

10. A signalling device according to claim 8, wherein said first array direction is parallel to said second direction.

11. A signalling device according to claim 6, wherein the array is a one dimensional array.

12. A signalling device according to any preceding claim, wherein said modulator and said reflector are formed as a single unit.

13. A signalling device according to claim 12, wherein said combined modulator and reflector comprises a quantum confined Stark effect device.

14. A signalling device comprising:
a plurality of detectors for converting light into corresponding electrical signals; and
a lens system for collecting light incident on the signalling device and for directing the incident light to at least one of the plurality of detectors which corresponds to the direction of incidence of the incident light,
wherein each detector extends a first length in a first direction and a second length, which is greater than twice the first length, in a second direction perpendicular to the first direction.

15. A signalling device according to claim 14, wherein the second length is greater than five times the first length.

16. A signalling device according to claim 14, wherein the second length is greater than ten times the first length.

17. A signalling device according to any of claims 14 to 16, wherein each detector is rectangular.

18. A signalling device according to any of claims 14 to 17, wherein the lens system is a telecentric lens system.

19. A signalling device according to any of claims 14 to 18, wherein the plurality of detectors are arranged in an array.

20. A signalling device according to claim 19, wherein the array is a two-dimensional array.

21. A signalling device according to claim 20, wherein the two-dimensional array has a plurality of detectors arranged in a first array direction and two detectors arranged in a second array direction.

22. A signalling device according to claim 21, wherein said first array direction is parallel to said first direction.

23. A signalling device according to claim 21, wherein said first array direction is parallel to said second direction.

24. A signalling device according to claim 19, wherein the array is a one dimensional array.

25. A signalling device according to any preceding claim, further comprising a housing including indication means indicative of the first and second directions.

26. A signalling device according to claim 25, wherein the indication means comprises a mark on the housing.

27. A signalling device according to claim 25, wherein the indication means is the shape of the housing.

28. A signalling device according to any of claims 25 to 27, wherein the housing further comprises mounting means for mounting the signalling device to a structure.

29. A signalling device according to claim 28, wherein the mounting means is operable to mount the signalling device in a plurality of different orientations.

30. A signalling device comprising:
a plurality of lens systems, each having a respective field of view;
an electro-optic device provided in common to said plurality of lens systems; and
a plurality of reflecting surfaces, each reflecting surface being associated with a corresponding one of the plurality of lens systems and being positioned relative to said associated lens system and said electro-optic device so that light incident on the associated lens system from the respective field of view is directed towards a respective different portion of said electro-optic device.

31. A signalling device according to claim 30, wherein the respective fields of view of the plurality of lens systems encompasses a 360° field of view in a plane.

32. A signalling device according to claim 30 or 31, wherein the plurality of reflecting surfaces are formed on a single body.

33. A signalling device according to claim 32, wherein the single body is pyramid-shaped.

34. A signalling device according to claim 32, wherein the single body is frustum-shaped.

35. A signalling device according to any of claims 30 to 34, wherein at least one of the plurality of lens systems comprises a telecentric lens.

36. A signalling device according to any of claims 30 to 35, wherein the electro-optic device comprises an array of light emitting elements, and wherein the plurality of lens systems are operable to direct light from the array of light emitting elements in respective different directions within their combined field of view.

37. A signalling device according to any of claims 30 to 35, wherein the electro-optic device comprises an array of detectors, and wherein each lens system is operable to direct light incident from different directions within its field of view towards respective different ones of the array of detectors.

38. A signalling device according to any of claims 30 to 35, wherein the electro-optic device comprises an array of modulator elements, and wherein each lens system is operable to direct light incident from different directions within its field of view towards respective different ones of the array of modulator elements.

39. A signalling device according to claim 38, wherein each modulator element has a reflectivity which is variable in accordance with an applied electrical signal.

40. A signalling device according to claim 39, wherein each modulator element comprises a quantum confined Stark effect device.

41. A signalling system comprising a first signalling device and a plurality of second signalling devices,
wherein the first signalling device comprising a signalling device according to claim 1 or any claim dependent thereon,
and wherein each of the plurality of second signalling devices comprises: i) at least one light emitter for emitting a light beam; ii) a lens system for directing the emitted light beam towards the first signalling device and for collecting a modulated light beam received from the first signalling device; and iii) at least one detector for detecting said modulated light beam and for converting the modulated light beam into a corresponding electrical signal.

42. A method of installing a signalling system for communicating data between a first signalling device and a plurality of second signalling devices associated with respective users distributed throughout a region of space, the method comprising the steps of:
providing a plurality of signalling devices as claimed in any of claims 1 to 29, wherein the plurality of signalling devices have different combinations and/or orientations of said first and second lengths;
analysing the environment of said region of space to determine a likely distribution of users;
selecting a signalling device from the plurality of signalling devices to form the first signalling device in accordance with the likely distribution of users determined in the analysing step; and
installing the signalling device selected in the selecting step.

43. A method according to claim 42, wherein the installing step comprises the steps of identifying the orientation of the first and second directions and mounting the signalling device in accordance with said identified orientation.

44. A method according to claim 43, wherein said identifying step comprises examining a housing of the signalling device for an indication of the orientation.

45. A method according to claim 43, wherein said identifying step comprises directly viewing the plurality of modulator elements through the lens system.

46. A signalling system comprising a first signalling device and a plurality of second signalling devices, the plurality of second signalling devices being provide on a building,
wherein the first signalling device comprising a signalling device according to claim 1 or any claim dependent thereon,
wherein each of the plurality of second signalling devices comprises: i) at least one light emitter for emitting a light beam; ii) a lens system for directing the emitted light beam towards the first signalling device and for collecting a modulated light beam received from the first signalling device; and iii) at least one detector for detecting said modulated light beam and for converting the modulated light beam into a corresponding electrical signal,
and wherein said first length and said second length are selected in accordance with a distribution of users within the building.

47. A signalling system according to claim 46, wherein the first direction corresponds to a vertical direction on a side of the building and the second direction corresponds to a horizontal direction on said side of the building.

48. A signalling system according to claim 46 or 47, wherein the building is a multi-storey building.

49. A signalling system comprising a first signalling device, a plurality of second signalling devices moveable relative to the first signalling device, and guide means for guiding the relative movement between each second signalling device and the first signalling device to be in a guide direction,
wherein the first signalling device comprising a signalling device according to claim 1 or any claim dependent thereon,
wherein each of the plurality of second signalling devices comprises: i) at least one light emitter for emitting a light beam; ii) a lens system for directing the emitted light beam towards the first signalling device and for collecting a modulated light beam received from the first signalling device; and iii) at least one detector for detecting said modulated light beam and for converting the modulated light beam into a corresponding electrical signal,
and wherein said second direction corresponds to the guide direction.

50. A signalling system according to claim 49, wherein the guide means comprises a road, and each of the plurality of second signalling devices is mounted on a road vehicle.
